(19) United States
(12) Patent Application Publication
(10) Pub. No.: US 2026/0054619 A1
(43) Pub. Date: Feb. 26, 2026

(54) SEAT

(71) Applicant: TOYOTA BOSHOKU KABUSHIKI KAISHA, Aichi (JP)

(72) Inventors: Naoki MITSUOKA, Miyoshi-shi, Aichi-ken (JP); Yukinori SUGIURA, Nisshin-shi, Aichi-ken (JP); Kenichi TSUKAMOTO, Okazaki-shi, Aichi-ken (JP); Kazuki OSHIMA, Nisshin-shi, Aichi-ken (JP); Takashi SAKAGUCHI, Tokoname-shi, Aichi-ken (JP)

(73) Assignee: TOYOTA BOSHOKU KABUSHIKI KAISHA, Aichi (JP)

(21) Appl. No.: 19/120,072

(22) PCT Filed: Oct. 12, 2023
(86) PCT No.: PCT/JP2023/037001

§ 371 Date: Apr. 10, 2025

(30) Foreign Application Priority Data
Oct. 18, 2022 (JP) 2022-166731

(51) Int. Cl. B60N 2/30; B60N 2/68; B60N 2/90

(52) U.S. Cl. CPC B60N 2/3038; B60N 2/68; B60N 2/986

(57) ABSTRACT

A vehicle seat includes a cushion body that elastically supports a seater, and a cushion frame that supports the cushion body from the back side of the seat. The cushion body is provided with three divided elements, specifically a main member that forms a central portion in a seat width direction, and side members that form two side portions in the seat width direction. The main member has a main pad including a pad body and a pad reinforcing portion. The pad body includes a polyurethane form molding. The pad reinforcing portions are made of a harder foamed bead molding and are disposed along both edges of the back side of the pad body. The pad reinforcing portions include foamed bead molding that is harder than the pad body.

### CROSS-REFERENCE TO RELATED APPLICATIONS

The present application is a U.S. National Phase entry of, and claims priority to, PCT Application PCT/JP2023/037001, filed Oct. 12, 2023, which claims priority to Japanese Patent Application No. 2022-166731, filed Oct. 18, 2022, both of which are incorporated herein by reference in their entireties for all purposes.

### BACKGROUND

One embodiment of the present disclosure relates to a seat. Specifically, the present disclosure relates to a seat having a cushion body that elastically supports a seater, and a seat frame that supports the cushion body from the backside of the seat.

A vehicle seat disclosed in Japanese Patent Publication No. 2020-33005 has a cushion body comprising a seat pad and a seat cover. The cushion body is divided into three parts in a seat width direction. Specifically, the cushion body has a configuration in which a main member that forms a central portion in the seat width direction and each side member that forms both side portions in the seat width direction. The main member and each side member are individually assembled and fixed to a seat frame.

In the configuration described in the above publication, the main member is separated from the side members. This causes a problem in that the main member is prone to swaying when the vehicle is subjected to lateral acceleration. Therefore, there has been a need for a vehicle seat for enhancing lateral stability and cushioning.

### SUMMARY

According to one aspect of the present disclosure, the seat comprises a cushion body that elastically supports a seater and a seat frame that supports the cushion body from a back side of a seat. The cushion body is divided into a central main member in a seat width direction and two side members in a seat width direction. The main member features a pad body made of a polyurethane foam molding and a pad reinforcing portion made of harder foamed bead molding, such as expanded polypropylene. This reinforcing portion is positioned along the edges of the pad body to increase rigidity and reduce lateral swaying.

Therefore, the rigidity of both edges of the pad back side of the main member is increased by the pad reinforcing portion. The main member is less likely to sway sideways against lateral acceleration.

### BRIEF DESCRIPTION OF DRAWINGS

FIG. 1 is a perspective view showing a schematic configuration of a seat according to one embodiment.

FIG. 2 is a side view of a seat cushion.

FIG. 3 is a plan view of the seat cushion.

FIG. 4 is an exploded perspective view in which a cushion body is removed from a cushion frame.

FIG. 5 is a plan view of the cushion frame.

FIG. 6 is a bottom view of the cushion body.

FIG. 7 is a cross-sectional view taken along line VII-VII of FIG. 3.

FIG. 8 is a cross-sectional view taken along line VIII-VIII of FIG. 3.

FIG. 9 is an enlarged view of part IX in FIG. 8.

FIG. 10 is a cross-sectional view taken along line X-X of FIG. 3.

FIG. 11 is a perspective view illustrating a state before one of side members is assembled to a side frame.

FIG. 12 is a perspective view illustrating a state after one of side members is assembled to the side frame.

FIG. 13 is a cross-sectional view taken along line XIII-XIII of FIG. 12.

### DETAILED DESCRIPTION

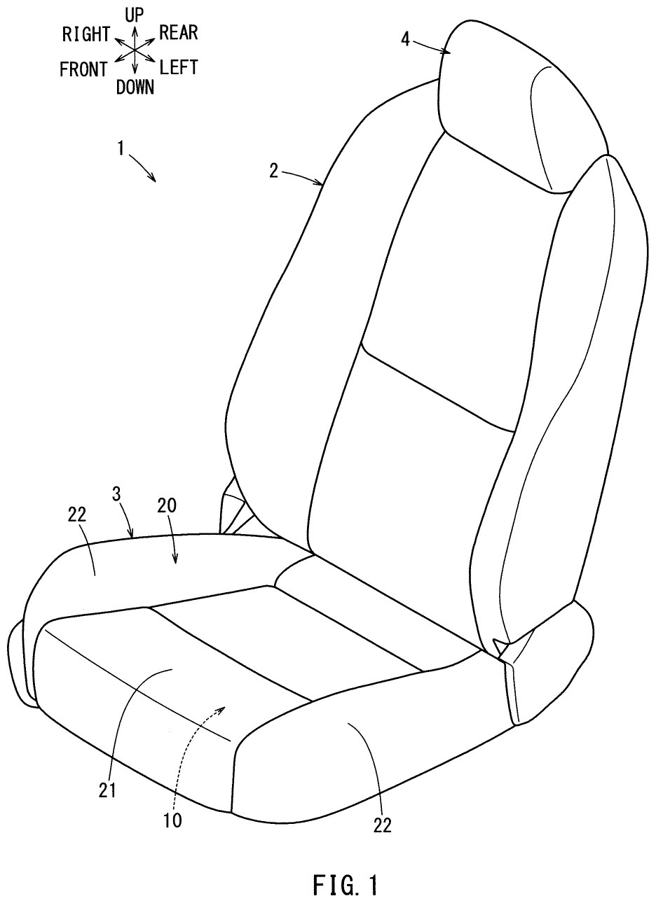

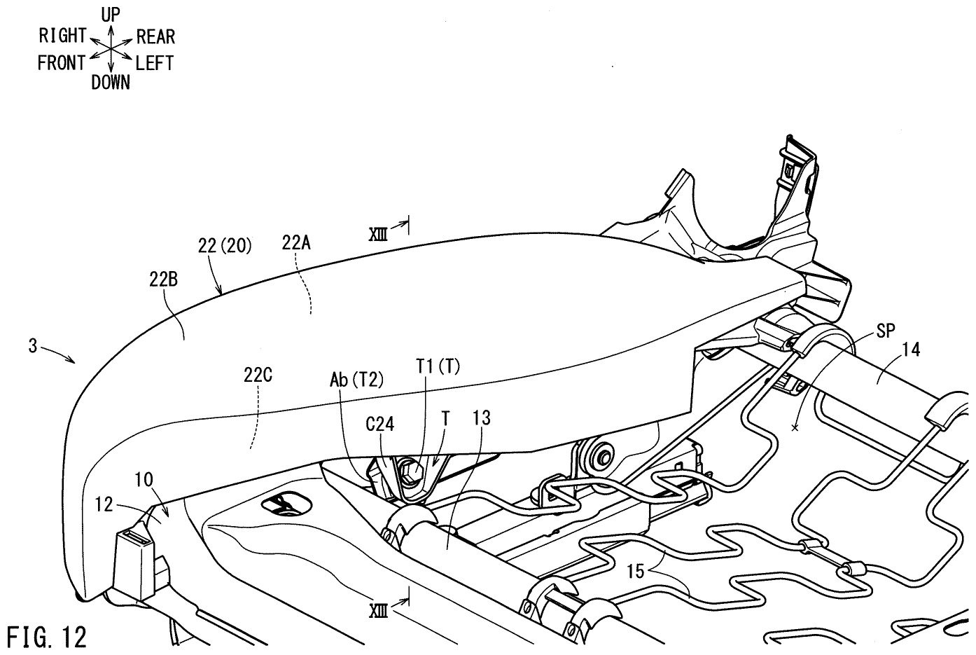

A configuration of a seat 1 according to one embodiment of the present disclosure will be described with reference to FIGS. 1 to 13. In the following description, explanations regarding the directions shall be based on the respective directions of up/down, front/rear, right/left as shown in each figure. The direction used with the “seat” refers to the direction based on the orientation of the seat 1. In the following description, a specific reference figure is not shown, or when there is no reference number corresponding to the reference figure, any of FIGS. 1 to 13 is referred to as appropriate.

As shown in FIG. 1, the seat 1 according to the present embodiment is the right-side seat for one person mounted on a floor of an automobile. The seat 1 includes a seat back 2 forming a backrest portion of a seater, a seat cushion 3 forming a seating portion, and a headrest 4 forming a head rest portion.

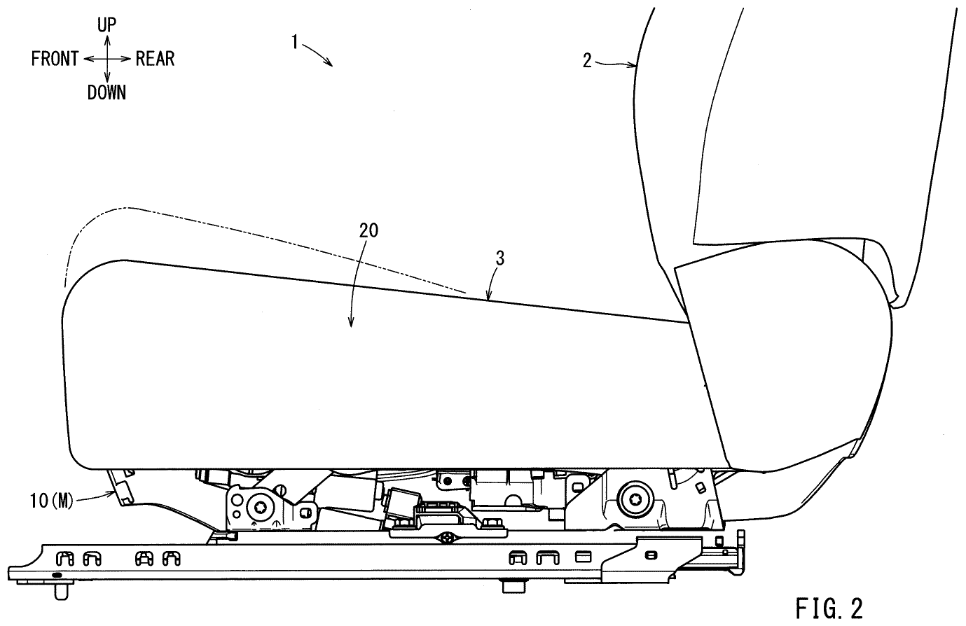

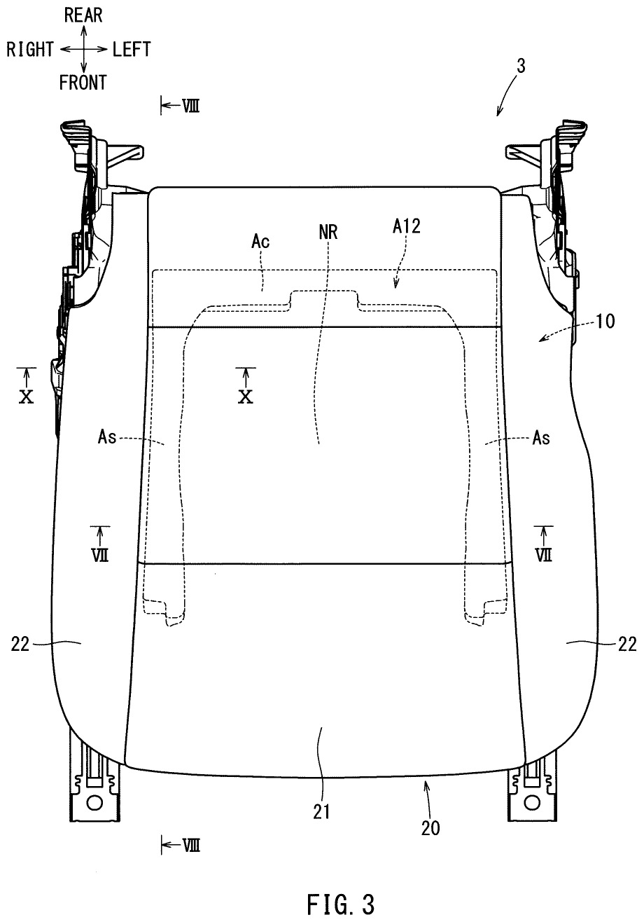

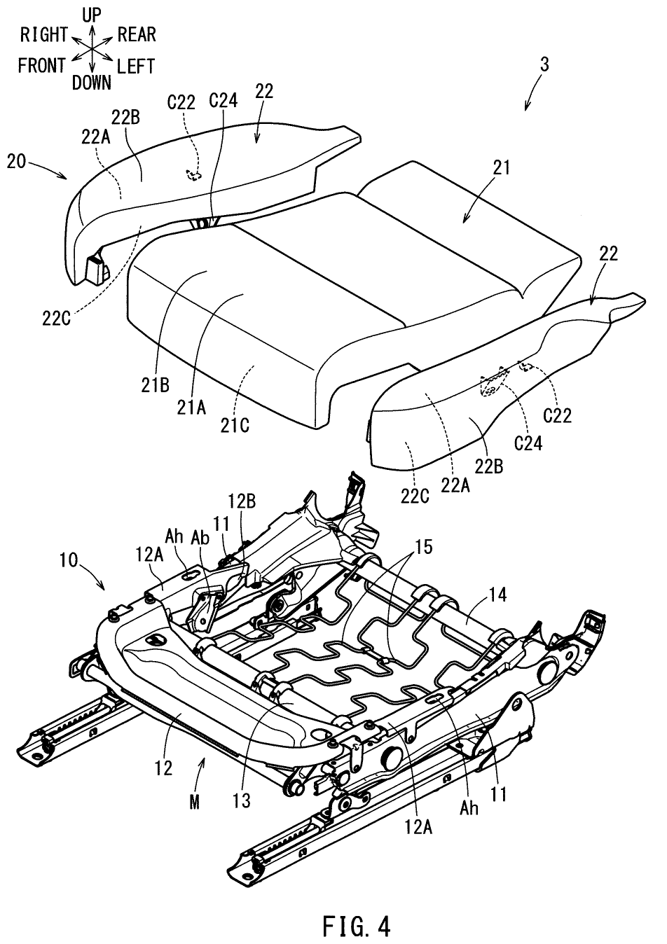

As shown in FIG. 2, the seat cushion 3 has a tilt mechanism M that adjusts the angle of the seat surface of the seat front portion. As shown in FIGS. 3 and 4, the seat cushion 3 has a cushion frame 10 and a cushion body 20. The cushion frame 10 forms the framework of the seat cushion 3. The cushion body 20 is assembled on the cushion frame 10 and elastically supports the buttocks and thighs of a seater. The cushion frame 10 corresponds to a “seat frame.”

As shown in FIG. 4, the cushion body 20 comprises three divided members. The cushion body 20 is divided into a main member 21, which forms a central portion in a seat width direction, and each side member 22, which forms both side portions in the seat width direction. The main member 21 supports the buttocks and thighs of the seater from below. The main member 21 has a generally flat surface shape. The upper surface of the main member 21 is slightly raised toward the front.

As shown in FIG. 1, each side member 22 supports the buttocks and thighs of the seater from below and obliquely outward. Each side member 22 has an upper surface which is the surface-side of the seat. The upper surface rises obliquely toward the outside in the seat width direction.

As shown in FIG. 4, the main member 21 and each side member 22 are individually assembled to the cushion frame 10 from the upper side of the seat. Therefore, the main member 21 and each side member 22 can be easily attached to and detached from the cushion frame 10 without removing the seat 1 from the floor.

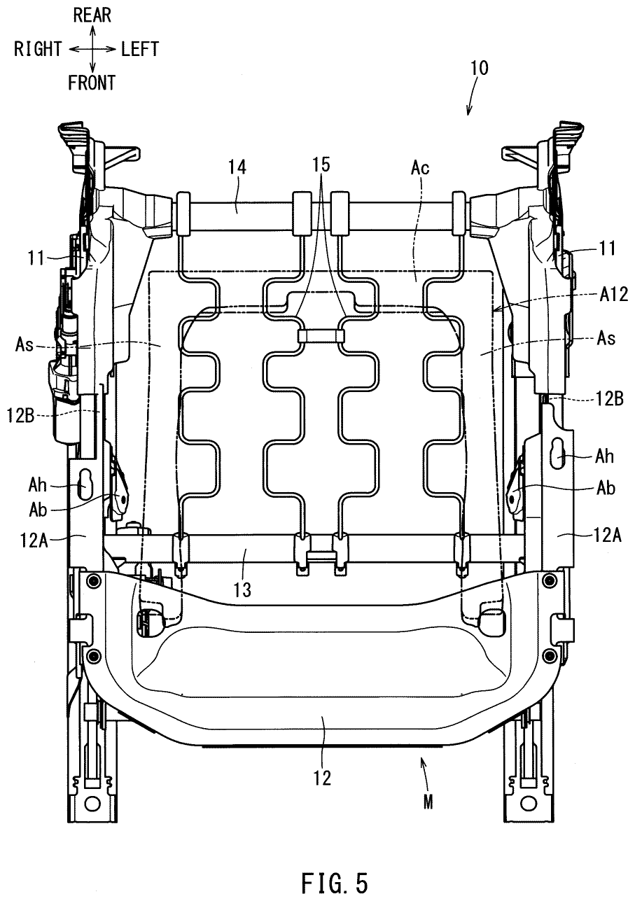

A configuration of each part of the seat cushion 3 will be described. As shown in FIGS. 4 and 5, the cushion frame 10 has a pair of right and left lower arms 11 extending in the front-rear direction along the right and left sides of the seat cushion 3. The cushion frame 10 further includes a tilt panel 12 extending across the front ends of the lower arms 11 in a planar shape. The cushion frame 10 also has a pair of right and left tilt arms 12A extending rearwardly from both edges of the tilt panel 12.

The rear end of each tilt arm 12A is connected to the middle of the lower arm 11 in a rotatable manner by a tilt rotation shaft 12B extending in the seat width direction. Each tilt arm 12A is tilted vertically about each tilt rotation shaft 12B by a drive unit (not shown) attached to the cushion frame 10.

As each tilt arm 12A tilts up and down, the tilt panel 12 moves up and down relative to each lower arm 11, changing the angle of the tilt panel 12. Thereby, the seat surface angle of the front portion of the seat cushion 3 is adjusted. The above-mentioned tilt mechanism M is constituted by a mechanism that enables the angle of the tilt panel 12 to be adjusted relative to each lower arm 11. The tilt panel 12 corresponds to a “movable part.”

The cushion frame 10 further has a front pipe 13 and a rear pipe 14. The front pipe 13 is a round pipe that is connected between the front portions of the lower arms 11. The front pipe 13 is located behind and below the tilt panel 12. The rear pipe 14 is a round pipe that is connected between the rear portions of the lower arms 11. The front pipe 13 and the rear pipe 14 each correspond to a “reinforcing frame.”

As shown in FIGS. 4 and 5, a plurality of (for example, four) support springs 15 are disposed between the front pipe 13 and the rear pipe 14 of the cushion frame. The support spring 15 is bent in a wavy shape in the front-rear direction and the left-right direction (the seat width direction). The support spring 15 elastically supports the main member 21 of the cushion body 20 from below.

As shown in FIG. 4, each tilt arm 12A has an L-shaped cross section with a side portion covering the inner side surface of the lower arm 11 and an upper portion covering the upper side surface of the lower arm 11. A fastening bracket Ab, which has a plate-shape, is welded to the lower part of the side portion of the tilt arm 12A, and extends obliquely downward toward the inside in the seat width direction.

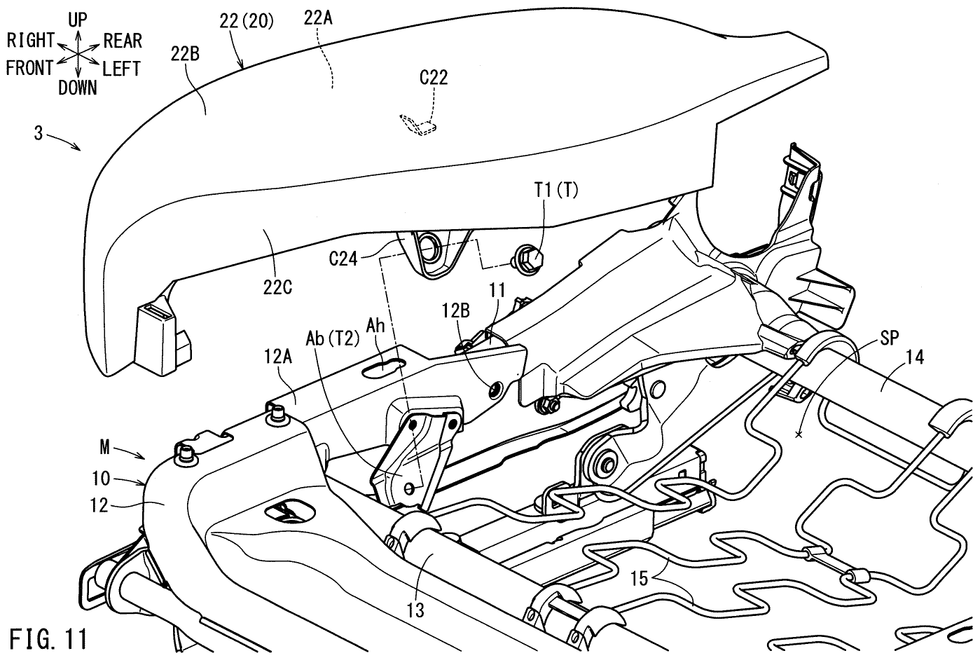

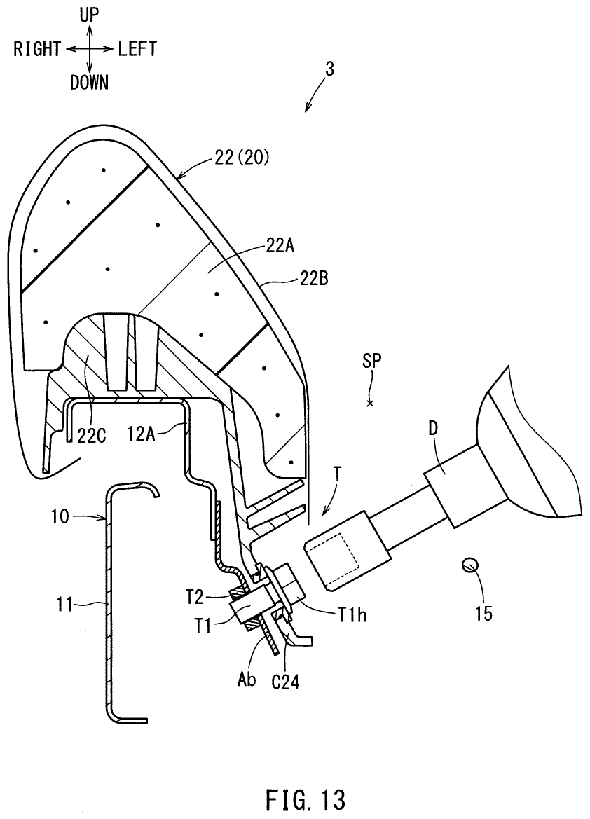

As shown in FIGS. 4 and 5, each fastening bracket Ab is arranged at a position rearward and below the front pipe 13. Specifically, each fastening bracket Ab is disposed at a position lower than the support spring 15. Each fastening bracket Ab has an upper surface (an interposing surface) that faces inwardly and obliquely upward. The upper surface faces the installation space of the main member 21. As shown in FIG. 13, the fastening bracket Ab is located directly below the inner side of the side member 22. A side resin member 22C is provided on the back side of the side member 22. As shown in FIG. 11, a fastening portion C24 extends from the side resin member 22C. The fastening portion C24 is fastened to the fastening bracket Ab by a fastening structure T.

As shown in FIG. 11, an engaging hole Ah, which extends in the seat front-rear direction, is formed in the upper portion of each tilt arm 12A. The engaging hole Ah is engaged with an engaging claw C22 formed on the side member 22. Specifically, the engaging claw C22 is formed on the side resin member 22C provided on the seat back side of the side member 22. The engaging claw C22 is inserted into the engaging hole Ah from above and slid toward the seat rear direction, whereby the engaging claw C22 is hooked onto the periphery of the engaging hole Ah.

As shown in FIGS. 4 and 6 to 8, the main member 21 has a main pad 21A, a main cover 21B, and a main resin member 21C. The main pad 21A is a cushioning portion. The main cover 21B is a fabric cover that covers the main pad 21A. The main resin member 21C is arranged on the front portion of the back side of the main pad 21A. The main resin member 21C corresponds to a “supporting member.”

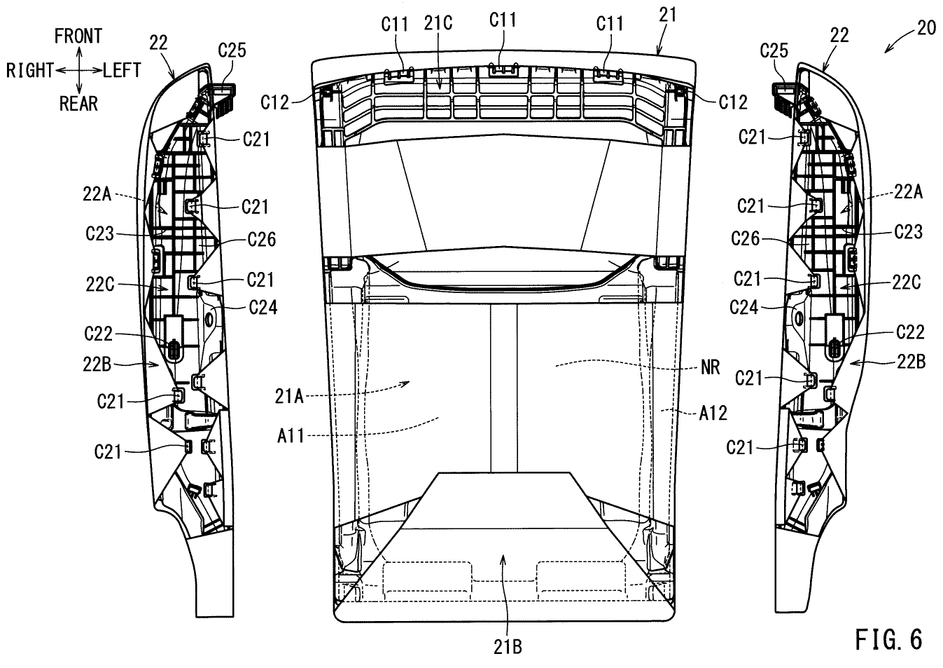

As shown in FIGS. 6 to 8, the main pad 21A has a pad body A11 and a pad reinforcing portion A12. The pad body A11 is made of a polyurethane foam molding. The pad reinforcing portion A12 is made of a bead foam molded body of expanded polypropylene. For example, the pad reinforcing portion A12 has U-shaped in a plan view. The pad reinforcing portion A12 is integrated with the pad body A11 during the foam molding process, ensuring a continuous and robust structure.

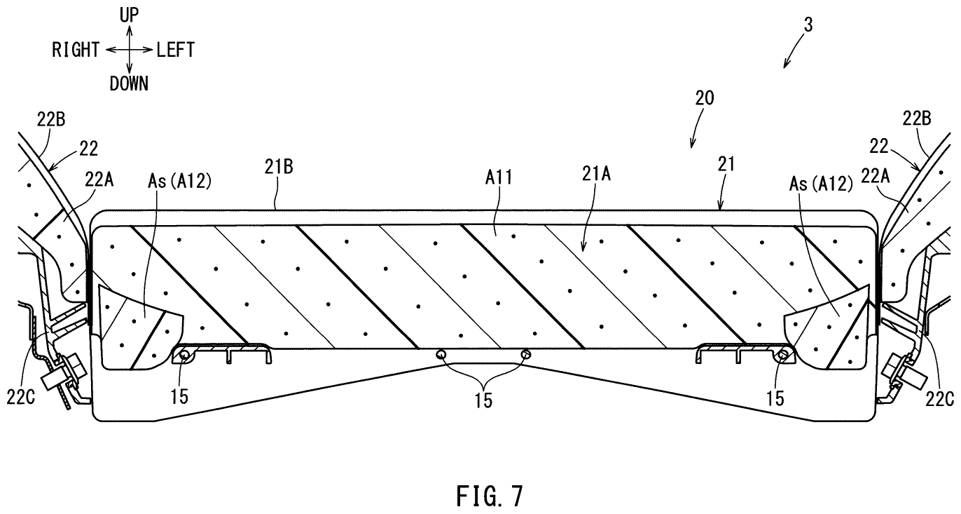

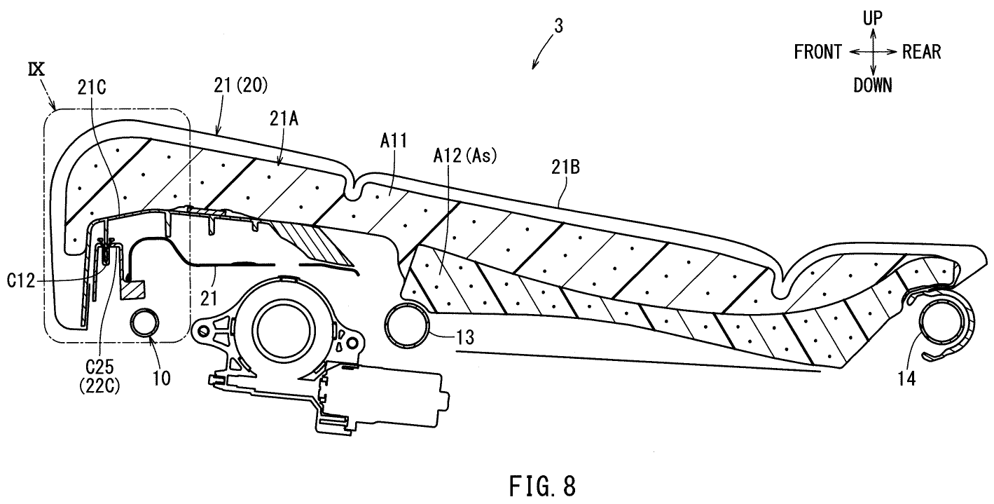

As shown in FIG. 5, the U-shaped pad reinforcing portion A12 has right and left side portions As and a connecting portion Ac. As shown in FIGS. 7 and 8, the side portions As extends in the seat front-rear direction along both right and left edges of the back side of the pad body A11 (both edges of the pad back side). The connecting portion Ac extends in the seat width direction connecting the rear ends of the side portions As. The pad reinforcing portion A12 is harder than the pad main body A11. The pad reinforcing portions A12 are arranged along the lower side of the rear, right, and left edges of the pad body A11. Therefore, the pad reinforcing portion A12 does not impair the cushioning properties of the main member 21. The pad reinforcing portion A12 serves to appropriately suppress lateral shaking of the main member 21.

As shown in FIG. 4, the main member 21 is set on the cushion frame 10. As shown in FIG. 8, the front part of the side portions As of the pad reinforcing portion A12 are supported by the front pipe 13 from below. The rear part of each side portions As are supported by the rear pipe 14.

As shown in FIG. 8, the connecting portion Ac of the pad reinforcing portion A12 extends along the rear pipe 14 and is supported by the rear pipe 14 from below. When the weight of the seater is applied to the main member 21, the front portions of the side portions As are supported by the front pipe 13. The rear portions of the side portions As and the connecting portion Ac are supported by the rear pipe 14. The connecting portion Ac is supported from below the seat by the rear pipe 14 over a wide range in the seat width direction.

By being supported as described above, the pad reinforcing portion A12 can appropriately suppress the lateral movement of the main member 21 when the vehicle is subjected to lateral acceleration. On the other hand, the pad reinforcing portion A12 is not arranged above the tilt panel 12 and does not interfere with its movement, as shown in FIG. 8. That is, the pad reinforcing portion A12 is not provided in the front area of the main pad 21A but from the middle to the rear area of the main pad 21A in the seat front-rear direction.

Since the pad reinforcing portion A12 has U-shape, the central area of the back side of the pad body A11 (the central area of the pad back side) is not reinforced by the pad reinforcing portion A12 (i.e., non-reinforced portion NR). That is, the main pad 21A has a non-reinforced portion NR in the central area of the pad back side. Both side portions and the rear portion of the pad back side of the main pad 21A have the pad reinforcing portion A12. Therefore, the main pad 21A appropriately suppresses lateral shaking without compromising the cushioning properties.

The main cover 21B is placed on the main pad 21A from above the seat. As shown in FIG. 6, the front, rear, right and left peripheral edges of the main cover 21B are pulled into and fastened to the back surface of the main pad 21A. Specifically, from the middle to rear area of the seat in the front-rear direction, where the pad reinforcement portion A12 of the main pad 21A is arranged, the right and left ends of the main cover 21B, which are pulled into the back surface of the pad, are hooked together and fastened to the back surface. The rear edge of the main cover 21B, which is pulled into the back surface of the pad, is fastened to the back surface of the main pad 21A by a fastener (not shown).

As shown in FIG. 6, the U-shaped main resin member 21C is disposed on the back surface of the main pad 21A. In the front area of the main pad 21A, the main cover 21B is fastened to the main resin member 21C by hooking the right, left and front ends which are pulled into the rear surface of the pad. Accordingly, the main cover 21B is stretched over the entire outer surface of the main pad 21A. In addition, the main resin member 21C is fixed in a state where it is pressed against the back surface of the main pad 21A by hooking the ends of the main cover 21B to the main resin member 21C.

The main resin member 21C is made of an injection molded product. The main resin member 21C is disposed on the front part of the pad back side, where is forward of the area in which the pad reinforcing portion A12 of the main pad 21A is arranged. Specifically, the main resin member 21C extends along both right and left edges and the front edge of the main pad 21, thereby the main resin member 21C is formed in U-shape in plan view.

Cover hooking claws C11 are formed on the center, right and left portions of front portion of the main resin member 21C. The end of the main cover 21B that is pulled into the pad back surface is fastened to the cover hooking claws C11. Engaging claws C12, which are a resilient claw protruding below the seat, are attached to both right and left end portions of the front portion of the main resin member 21C.

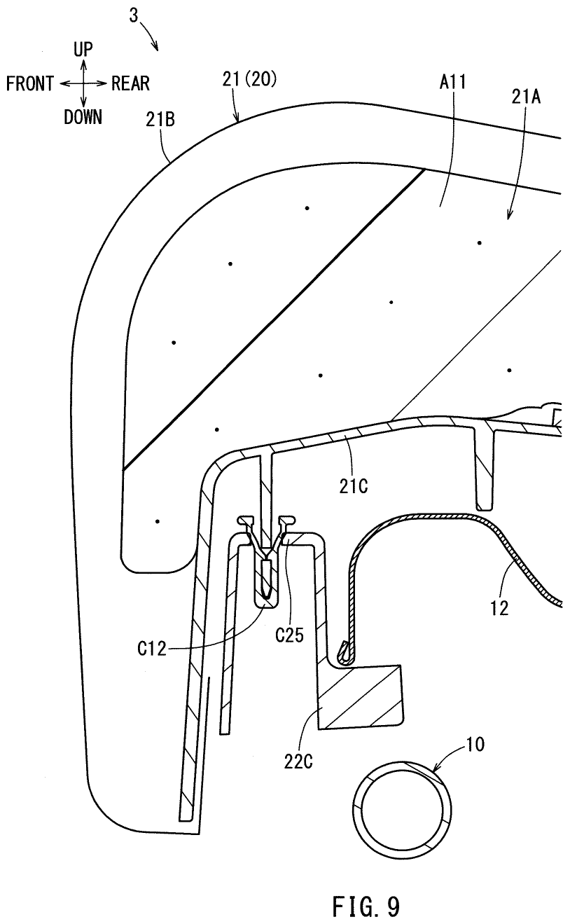

The main member 21 is set on the cushion frame 10 from above the seat. At this time, as shown in FIGS. 8 and 9, the engaging claw C12 of the main resin member 21C is snap-fitted into an engaging portion C25 of the side member 22 by being pressed from above the seat. The side member 22 has the side resin member 22C that is assembled to a tilt panel 12. The engaging claws C12 are formed on the inside of the front end portion of the side resin member 22C. Therefore, the front end portion of the main member 21 is fixed to the cushion frame 10 via each side member 22 so as not to come off upward.

As shown in FIG. 9, the engaging claw C12 is configured to be easily released from the engaged state with the engaging portion C25 of each side member 22 by an operator applying force to pull up the front end of the main member 21 from below the seat when it is in the snap-fit engaged state.

As shown in FIG. 8, the main member 21 is assembled to the cushion frame 10 as follows. First, the rear portion of the main member 21 is inserted from the front of the seat so as to slip under the seat back 2 and set on the rear pipe 14. Next, the front portion of the main member 21 is pushed onto the tilt panel 12, using the rear portion of the main member 21 as a fulcrum.

Therefore, engaging claws C12 formed on the front end portion of the main resin member 21C are snap-fitted into the engaging portions C25 formed on the front end portions of the side members 22 (see FIG. 9). In this manner, the main member 21 is detachably assembled to the cushion frame 10 by only two actions: insertion from above the seat and engagement of the respective engaging claws C12.

As shown in FIGS. 4, 6 and 10, each side member 22 has a side pad 22A, a side cover 22B and the side resin member 22C, respectively. The side cover 22B is made of fabric and covers the side pad 22A, which is the cushioning portion of the side member. The side resin member 22C is disposed on the pad rear surface of the side pad 22A. Each side member 22 has a symmetrical configuration with the same basic structure.

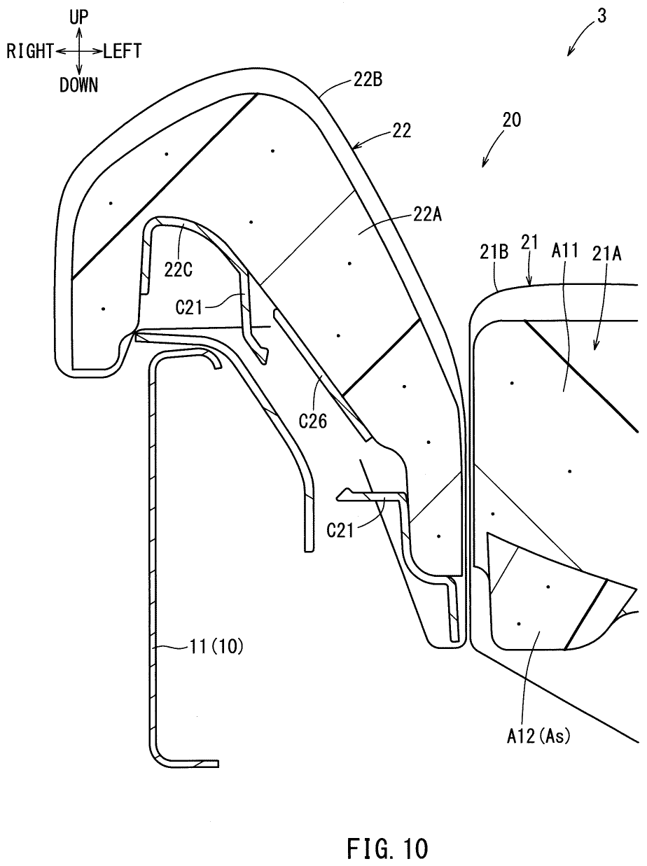

As shown in FIG. 10, the side pad 22A is made of a polyurethane foam molding. The pad surface of the side pad 22A, which is a surface on the seat upper side, has a shape with a bank-like overhang. The pad surface swells obliquely above the seat from the inside to the outside in the seat width direction. The side pad 22A has a rear surface that is hollowed out to be recessed along the bank-like overhang rising. That is, the rear surface of the pad is formed into a concave curved surface shape with the rear surface hollowed out.

As shown in FIG. 10, the side cover 22B is placed on the side pad 22A from above the seat. The front, rear, right and left peripheral edges of the side cover 22B are pulled into and fastened to the back side of the side pad 22A. Specifically, as shown in FIG. 6, the front, rear, right and left ends of the side cover 22B are pulled into the back side of the side pad 22A. Each end of the side cover 22B is hooked and fastened to the side resin member 22C provided along the back side of the side pad 22A.

By being hooked as described, the side cover 22B is stretched over the entire outer surface of the side pad 22A, ensuring a snug and secure fit. The side resin member 22C is fixed in a state of being pressed against the back surface of the side pad 22A by hooking each end of the side cover 22B.

As shown in FIGS. 6 and 10, the side resin member 22C is made of an injection molded product having a curved shape. The side resin member 22C has a shape that conforms to the concave curved surface of the back surface of the side pad 22A. The side resin member 22C has a side support portion C26, which extends obliquely along the bank-shaped protrusion of the side pad 22A. Therefore, the side support portion C26 supports the bank-shaped protrusion of the side pad 22A from the pad back side in a planar manner. This allows the side pad 22A to appropriately support the body of the seater.

As shown in FIGS. 6 and 10, cover hooking claws C21 are formed in a peripheral edge of the side resin member 22C. Each end pulled into the back side of the side cover 22B are hooked to the cover hooking claw C21. As shown in FIG. 6, the engaging claw C22 is formed in the approximately central area of the side resin member 22C. The engaging claw C22 has a hook-shape. The engaging claw C22 protrudes downward from the concave curve of the side resin member 22C. When the side member 22 is attached to the cushion frame 10 (see FIG. 11) from above, the engaging claw C22 is inserted from above into an engaging hole Ah formed in the upper surface of the tilt arm 12A.

Next, the side member 22 is slid rearward relative to the cushion frame 10, so that the engaging claw C22 is hooked into the engaging hole Ah from the front. By being hooked as described above, the side member 22 is fixed to the tilt arm 12A so that it does not slip out above the seat.

As shown in FIG. 6, a guide portion C23 is formed on the lower surface of the side resin member 22C. The guide portion C23 is located in the upper area of the concave curve of the side resin member 22C. The guide portion C23 has an L-shaped cross section. The guide portion C23 has a substantially horizontal portion and a protruding portion that protrudes downward from the horizontal portion. By assembling the side member 22 to the cushion frame 10 (see FIG. 11) from above, the horizontal portion of the guide portion C23 abuts against the upper surface of the tilt arm 12A. The protruding portion of the guide portion C23 abuts against the outer side of the tilt arm 12A. Thereby, the guide portion C23 regulates the assembly position of the side member 22 relative to the cushion frame 10 in the seat width direction.

As shown in FIGS. 11 to 13, the fastening portion C24 is formed in the intermediate area of the side resin member 22C in the seat front-rear direction. The fastening portion C24 has a plate-shape. The fastening portion C24 extends obliquely downward toward the inside in the seat width direction from the inner edge of the side resin member 22C. The fastening portion C24 is superimposed on the upper surface of the fastening bracket Ab by assembling the side member 22 to the cushion frame 10.

Next, as shown in FIG. 13, a bolt T1, which is an insert-type fastening structure T, is inserted into the fastening portion C24 and the fastening bracket Ab. They are fastened by a fastening tool D (for example, an impact driver). Thereby, the fastening portion C24 is fastened to the fastening bracket Ab.

Specifically, as shown in FIG. 13, the fastening structure T consists of the bolt T1 described above and a weld nut T2. The weld nut T2 is welded to the lower surface (the surface behind the upper surface) of the fastening bracket Ab. A head T1h of the bolt T1 is set on the fastening tool D as a tool engaging portion. The leg of the bolt Tl is inserted into the fastening portion C24 and the fastening bracket Ab overlapping therewith by the fastening tool D, then fastened to the weld nut T2.

The upper surface of the fastening bracket Ab and the fastening portion C24 overlapping therewith faces an opening space SP, which is the installation space of the main member 21. Therefore, when fastening the bolt T1 using the fastening tool D, the opening space SP serves as a workspace, making it easy to access the fastening location. More specifically, the fastening operation can be performed by inserting only the tip of the fastening tool D obliquely into the fastening location without inserting the entire fastening tool D into the opening space SP.

In the present embodiment, the support spring 15 is assembled to the cushion frame 10 next to the above fastening portion. Even with this configuration, the above-mentioned fastening work can be performed without causing the fastening tool D to interfere with the support spring 15. By fastening as described above, the head T1h of the bolt T1 (the tool engagement portion) faces upward to the opening space SP. Therefore, when removing the bolt T1 from the fastened state, the fastening tool D can be inserted obliquely through the opening space SP in the same manner, and the bolt T1 can be easily loosened.

A method for assembling the cushion body 20 to the cushion frame 10 will be described. As shown in FIGS. 11 to 13, before the main member 21 is assembled to the cushion frame 10, each of the side members 22 is assembled to the cushion frame 10 (the side member assembly step). The method for assembling each side member 22 to the cushion frame 10 is as described above.

After assembling each side member 22, the main member 21 is assembled to the cushion frame 10 (the main member assembly step). According to the above steps, the cushion body 20 composed of three divided members can be easily and appropriately assembled to the cushion frame 10. The procedure of detaching the cushion body 20 from the cushion frame 10 is a procedure reverse to that described above.

The seat (1) according to the present embodiment is configured as follows. The seat (1) includes a cushion body (20) that elastically supports a seater, and a seat frame (a cushion frame (10)) that supports the cushion body (20) from the back side of a seat. The cushion body (20) comprises three divided members, which is divided into a main member (21) forming a central portion in a seat width direction and two side members (22) forming both side portions in the seat width direction.

The main member (21) has a main pad (21A) which includes a pad body (A11) and a pad reinforcing portion (A12). The pad body (A11) is made of a polyurethane foam molding, providing cushioning. The pad reinforcing portion (A12) is disposed along both edges of the back side of the pad body (A11). The pad reinforcing portion (A12) is made of a foamed bead molding which is harder than the pad body (A11).

According to the above configuration, the pad reinforcing portion (A12) increases the rigidity of both edges of the pad backside, making the main member (21) less likely to sway sideway against lateral acceleration.

Further, the main pad (21A) has a non-reinforced portion (NR), where the pad reinforcing portion (A12) is not provided, at the central area of the back side of the pad body (A11). According to the above configuration, the non-reinforced portion (NR) makes it possible to appropriately suppress lateral swaying of the main member (21) without compromising the cushioning of the main member (21).

In addition, the seat frame (10) comprises a pair of side frames (the lower arms (11)) and a pair of reinforcing frames (a front pipe (13) and a rear pipe (14)) positioned to bridge between the pair of side frames (11). The pad reinforcing portion (A12) extends continuously between the pair of reinforcing frames (13, 14). The pad reinforcing portion (A12) abuts against the pair of reinforcing frames (13, 14) from the seat surface side. According to the above configuration, the rigidity of both edge portions on the pad back side of the main member (21) can be further appropriately increased. The main member (21) can be made less likely to shift laterally relative to the seat frame (10). Thereby, it is possible to more appropriately suppress lateral swaying of the main member (21).

Further, the pad reinforcing portion (A12) has side portions (As) and a connecting portion (Ac). Each side portion (As) extends along both edges of the back side of the pad body (A11) in the seat front-rear direction. The connecting portion (Ac) extends in the seat width direction connecting between the side portions (As). This connecting portion (Ac) extends along one of the pair of reinforcing frames (13, 14) and abuts against one of the reinforcing frames either the front pipe (13) or the rear pipe(14) from the seat surface side. According to the above configuration, the pad reinforcing portion (A12) has a continuous configuration in which side portions (As) are connected by the connecting portion (Ac). The rigidity of both edges of the pad back side of the main member (21) is more appropriately increased. This makes it possible to more appropriately suppress lateral shaking of the main member (21).

The seat frame (10) is a frame for a seat cushion (3) having a tilt mechanism (M) that is configured to adjust the angle of the seat front portion. The pad body (A11) of the main member (21) has a front portion that is moved by adjusting the seat angle. A resin member (a main resin member (21C)) that is not connected to the pad reinforcing portion (A12) is disposed on the front portion of the back side of the pad body (A11) (the front portion of the pad back side). A main cover (21B) is placed on the main pad (21A). The end of the main cover (21B) is fastened to a resin member. The main member (21) is indirectly fixed to a movable part (a tilt panel (12)) of a tilt mechanism (M) by a resin member.

According to the above configuration, it is possible to properly provide the pad reinforcement portion (A12) on the main member (21) of the seat cushion (3) without interfering with the movement of the tilt mechanism (M). In addition, the resin member (the main resin member (21C)) can appropriately fasten the end of the main cover (21B) and fix the main member (21) to the movable part (12) of the tilt mechanism (M).

The bead form molding constituting the pad reinforcing portion (A12) includes expanded polypropylene. According to the above configuration, the main member (21) can be formed so as to exhibit appropriate cushioning properties and lateral sway suppression effects.

The present disclosure can be implemented in various forms, in addition to the embodiments described above.

The seat of the present disclosure may be configured as a seat cushion for a seat mounted in a vehicle other than an automobile, such as a train, aircraft, or ship. The present disclosure may be applied to a seat back instead of a seat cushion.

The pad reinforcing portion of the present disclosure is made of an expanded polypropylene. Alternatively, the pad reinforcing portion may be made of a bead foam molding including Styrofoam. The pad reinforcing portion may be made of a bead foam molding that is a combination of expanded polypropylene and Styrofoam. As described above, the pad reinforcing portion has right and left side portions As and the connecting portion Ac. Alternatively, the pad reinforcing portion may not have the connecting side portion Ac and may have only the right and left side portions As.

The pad reinforcing portion is provided across the pair of reinforcing frames. Alternatively, the pad reinforcing portion may be placed on only one of the pair of reinforcing frames, or may be disposed between the pair of reinforcing frames. The pad reinforcing portion has the connecting portion that extends along the rear pipe. Alternatively or in addition to this, the pad reinforcing portion may have a connecting portion that extends along the front pipe, and the connecting portion may abut against the front pipe from the seat front side. The pair of reinforcing frames are pipes. Alternatively, the reinforcing frame may be in the form of a panel.

The pad reinforcing portion is integrally formed with the pad body. Alternatively, the pad reinforcing portion may not be integrated with the pad body, but may be fixed to the seat frame. Alternatively, the pad reinforcing portion may be configured to be integral with the pad body by fastening the end of the main cover that is placed on the main pad to the supporting member.

The supporting member provided on the main member may be made of metal other than resin. The supporting member is indirectly fixed to the movable portion of the tilt mechanism. Alternatively, the supporting member may be fixed directly to the movable portion of the tilt mechanism. The main cover and the side cover may each be made of leather other than fabric.

According to another aspect of the present disclosure, the central area of the back side of the pad body is not reinforced, maintaining the cushioning properties of the main member while still suppressing lateral swaying.

Therefore, the non-reinforced portion makes it possible to appropriately suppress lateral swaying of the main member without compromising the cushioning of the main member.

According to another aspect of the present disclosure, the seat frame comprises a pair of side frames and a pair of reinforcing frames positioned to bridge between the pair of side frames. The pad reinforcing portion extends continuously between the pair of reinforcing frames. The pad reinforcing portion abuts against the pair of reinforcing frames from the seat surface side.

Therefore, the rigidity of both edge portions on the pad back side of the main member can be further appropriately increased. In addition, the main member can be made less likely to shift laterally relative to the seat frame. Thereby, it is possible to more appropriately suppress lateral swaying of the main member.

According to another aspect of the present disclosure, the pad reinforcing portion comprises side portions that extend along both edges of the back side of the pad body and a connecting portion that extends in the seat width direction so as to connect between the side portions. The connecting portion extends along one of the reinforcing frames. The connecting portion abuts against the reinforcing frame from the seat surface side.

Therefore, the pad reinforcing portion has a continuous configuration in which side portions are connected by the connecting portion. The rigidity of both edges of the pad back side of the main member is more appropriately increased. This makes it possible to more appropriately suppress lateral swaying of the main member.

According to another aspect of the present disclosure, the seat frame is a frame for a seat cushion having a tilt mechanism which is configured to adjust the seat cushion angle of the seat front portion. The main member has a main cover that covers the pad body, a front portion that is moved by adjusting the seat angle, and a supporting member disposed on the back side of the seat front portion. The supporting member is not connected to the pad reinforcing portion. The end of the main cover is fastened to the supporting member. The supporting member is fixed to a movable portion of the tilt mechanism.

Therefore, it is possible to properly provide the pad reinforcement portion on the main member of the seat cushion without interfering with the movement of the tilt mechanism. In addition, the supporting member can appropriately fasten the end of the main cover and fix the main member to the movable part of the tilt mechanism.

According to another aspect of the present disclosure, the bead foam molding constituting the pad reinforcing portion includes expanded polypropylene.

Therefore, the main member can be formed so as to exhibit appropriate cushioning properties and lateral sway suppression effects.

1. A seat comprising:
a cushion body that elastically supports a seater; and
a seat frame that supports the cushion body from a backside of the seat,
wherein the cushion body further comprises a main member forming a central portion in a seat width direction and two side members forming both side portions in the seat width direction, and wherein
the main member comprises a pad body that is made of a polyurethane foam molding, and a pad reinforcing portion that is made of a foamed bead molding which is harder than the pad body,

2. The seat according to claim 1, wherein the main member has a non-reinforced portion positioned at a central area of the back side of the pad body where the pad reinforcing portion is not provided.

3. The seat according to claim 1, wherein
the seat frame comprises a pair of side frames and a pair of reinforcing frames positioned to bridge between the side frames;

4. The seat according to claim 3, wherein
the pad reinforcing portion further comprises a side portion that extends along both edges of the back side of the pad body and a connecting portion that extends in the seat width direction so as to connect between the side portions;

5. The seat according to claim 1, wherein
the seat frame is a frame for a seat cushion having a tilt mechanism which is configured to adjust the seat cushion angle of the seat front portion,
the main member has a main cover that covers the pad body, a front portion that is moved by adjusting the seat angle, and a supporting member disposed on the seat back side of the front portion, and
the supporting member is not connected to the pad reinforcing portion, wherein an end of the main cover is fastened to the supporting member, and wherein the supporting member is fixed to a movable portion of the tilt mechanism.

6. The seat according to claim 1, wherein the pad reinforcing portion is made of foamed bead molding and has expanded polypropylene.

7. The seat according to claim 4, wherein the connecting portion extends along one of the reinforcing frames and abuts against thereof from the seat surface side.

8. The seat according to claim 1, wherein the pad reinforcing portion is disposed along both edges of the back side of the pad body.

9. The seat according to claim 1, wherein the pad reinforcing portion extends continuously between the pair of reinforcing frames and abuts against the reinforcing frames from a seat surface side.

10. The seat according to claim 1, wherein the pad reinforcing portion is configured to integrate with the pad body during a foam molding process for ensuring a continuous and robust structure.

11. A seat comprising:
a cushion body that elastically supports a seater; and
a seat frame that supports the cushion body from a backside of the seat, wherein the cushion body comprises
a main member having a pad body, a pad reinforcing portion, a main cover, and a main resin member, and
two side members, wherein each of the two side members has a side pad made of polyurethane foam molding, a side cover for covering the side pad, and a side resin member is disposed on a back side of the side pad.

12. The seat according to claim 11, wherein the pad reinforcing portion has a side portion that is extendable along both edges of the backside of the pad body in a seat front-rear direction.

13. The seat according to claim 11, wherein the pad reinforcing portion has a connecting portion configured to connect rear ends of the side potions, and wherein the connecting portion is extendable in a seat width direction.
